(19) United States
(12) Patent Application Publication
(10) Pub. No.: US 2023/0161865 A1
(43) Pub. Date: May 25, 2023

(54) INFORMATION PROCESSING APPARATUS THAT REGISTERS FUNCTION INFORMATION ALONG WITH USER INFORMATION, WHEN REREGISTERING USER INFORMATION ONCE DELETED

(71) Applicant: KYOCERA Document Solutions Inc., Osaka (JP)

(72) Inventor: Keiko MORITA, Osaka (JP)

(73) Assignee: KYOCERA Document Solutions Inc., Osaka (JP)

(21) Appl. No.: 17/990,154

(22) Filed: Nov. 18, 2022

(30) Foreign Application Priority Data
Nov. 25, 2021 (JP) 2021-191346

(51) Int. Cl. G06F 21/51; G06F 21/31

(52) U.S. Cl. CPC G06F 21/51; G06F 21/31

(57) ABSTRACT

An information processing apparatus includes a memory and an arithmetic device. The arithmetic device acts as a registerer that stores user information in the memory, a function information storage device that stores function information, related to a function utilized by a user indicated by the user information, in the memory in association with the user information, a history storage device that stores a function execution history in the memory, in association with the user information, and a deleter that deletes, when an event, predefined as trigger for reducing a number of pieces of user information, has occurred, one or more pieces of user information and the function information from the memory. The function information storage device stores, when the deleted user information is reregistered by the registerer, the function information corresponding to the execution history associated with the reregistered user information, in the memory in association with the user information.

### INCORPORATION BY REFERENCE

This application claims priority to Japanese Patent Application No. 2021-191346 filed on Nov. 25, 2021, the entire contents of which are incorporated by reference herein.

### BACKGROUND

The present disclosure relates to an information processing apparatus.

Information processing apparatuses having a printing function, a copying function, a scanning function, a facsimile function, or an e-mail function are currently known. In general, the information processing apparatus is shared by a plurality of users. Limitlessly permitting many users to utilize the information processing apparatus provokes troubles such as information leakage, and therefore the information processing apparatus is configured to perform user authentication. For example, a technique is known including storing a database, in which user information (user ID, password, domain name, and so forth) is registered, in the information processing apparatus in advance, and collating user information inputted by a user with the database, thereby deciding whether the user is permitted to use the information processing apparatus.

Another example of known techniques includes storing the database in a server connected to a plurality of information processing apparatuses via a network, to perform centralized management of all the users of the plurality of information processing apparatuses. Further, a technique is known including storing authorization information indicating whether the user is permitted to utilize the individual functions of the information processing apparatus (e.g., permitted to utilize the copying function, but not the facsimile function), in association with the user information of the user who is permitted to use the information processing apparatus. For the authorization information, the manager inputs predetermined initial settings, depending on the assigned area or class of position of the user. When the user wishes to utilize the function the initial setting of which is “Prohibited”, the manager may revise the authorization information from “Prohibited” to “Permitted”, upon the request from the user to the manager.

Still another example of the known techniques includes limiting the number of pieces of user information that may be registered, to avoid troubles such as an increase in operating cost, and congestion. However, when the number of registered users reaches the upper limit, a new user registration becomes unacceptable, which also incurs inconvenience. Therefore, a technique to delete, when the number of registered users has reached the upper limit, the registration of the user who last logged in at the earliest time, or the registration of the user lowest in priority specified in advance, has been proposed.

### SUMMARY

The disclosure proposes further improvement of the foregoing techniques.

In an aspect, the disclosure provides an information processing apparatus including a memory, and an arithmetic device. The arithmetic device includes a processor, and acts as a registerer, a function information storage device, a history storage device, and a deleter, when the processor executes a control program. The registerer stores user information in the memory. The function information storage device stores function information, related to a function to be utilized by a user indicated by the user information registered by the registerer, in the memory in association with the user information. The history storage device stores an execution history of the function in the memory, in association with the user information. The deleter deletes, when an event, predefined as trigger for reducing a number of pieces of user information registered by the registerer, has occurred, one or more pieces of user information and the function information from the memory, according to a predetermined rule. The function information storage device stores, when the user information deleted by the deleter is reregistered by the registerer, the function information corresponding to the execution history associated with the reregistered user information, in the memory in association with the user information.

### BRIEF DESCRIPTION OF THE DRAWINGS

FIG. 1 is a block diagram showing a general configuration of an information processing system;

FIG. 2 is a block diagram showing a hardware configuration of an image forming apparatus;

FIG. 3 is a block diagram showing a functional configuration of the image forming apparatus;

FIG. 4 is a table showing an example of user information;

FIG. 5 is a table showing an example of authorization information contained in function information;

FIG. 6 is a table showing an example of job execution history;

FIG. 7 is a flowchart showing a process of account management;

FIG. 8 is a flowchart showing a process of storing the authorization information; and

FIG. 9 is a table showing examples of set values contained in the function information.

### DETAILED DESCRIPTION

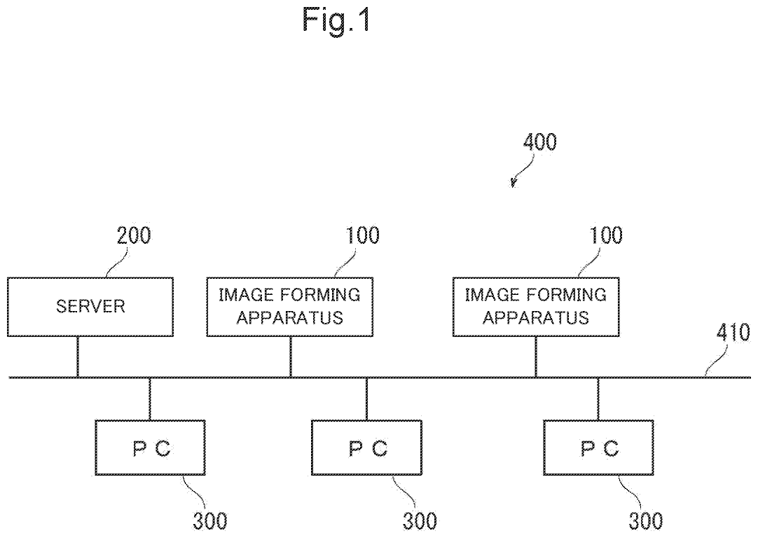

Hereafter, an information processing system 400 according to an embodiment of the disclosure will be described, with reference to the drawings. First, a general configuration of the information processing system 400 will be described. FIG. 1 is a block diagram showing the configuration of the information processing system 400. As shown in FIG. 1, the information processing system 400 includes a server 200, a plurality of personal computers (PC) 300, and a plurality of image forming apparatuses 100 (exemplifying the information processing apparatus in the disclosure), connected to one another via a local area network (LAN) 410.

The server 200 primarily manages user information related to users of the information processing system 400. The PC 300 primarily performs document editing, or transmission of a job to the image forming apparatus 100.

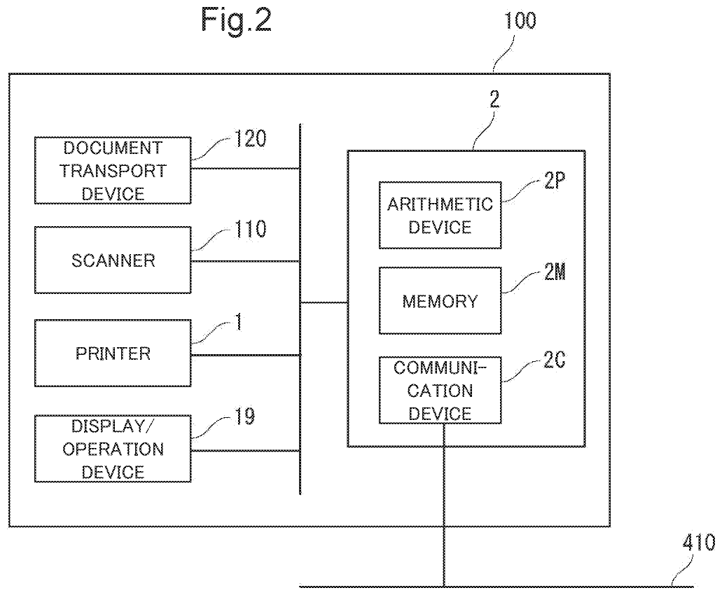

FIG. 2 is a block diagram showing a hardware configuration of the image forming apparatus 100. The image forming apparatus 100 includes a printer 1, a scanner 110, a document transport device 120, a controller 2, and a display/operation device 19. The document transport device 120 transports a source document, along a transport route passing the reading position of the scanner 110. The scanner 110 is a flat-bed image scanner. The scanner 110 reads the source document and generates image data. The printer 1 forms an image based on the image data, on a sheet.

The controller 2 includes an arithmetic device 2P, a memory 2M, and a communication device 2C. The arithmetic device 2P is, for example, a central processing unit (CPU). The memory 2M includes storage media such as a read-only memory (ROM), a random-access memory (RAM), an electrically erasable programmable read-only memory (FEPROM), or a hard disk drive (HDD). The arithmetic device 2P executes various operations, by reading out and executing a control program stored in the memory 2M. The communication device 2C is a communication interface for performing communication via the LAN 410. Here, the controller 2 may be configured so as to operate solely with an integrated circuit, without utilizing software.

The display/operation device 19 includes a display panel, a touch panel overlaid on the surface of the display panel, and a keypad located adjacent to the display panel. The controller 2 displays an operation menu of the printer 1 or the scanner 110, or the status thereof, on the display panel. The controller 2 controls the components of the printer 1 or the scanner 110, according to the operation inputted through the touch panel or the keypad.

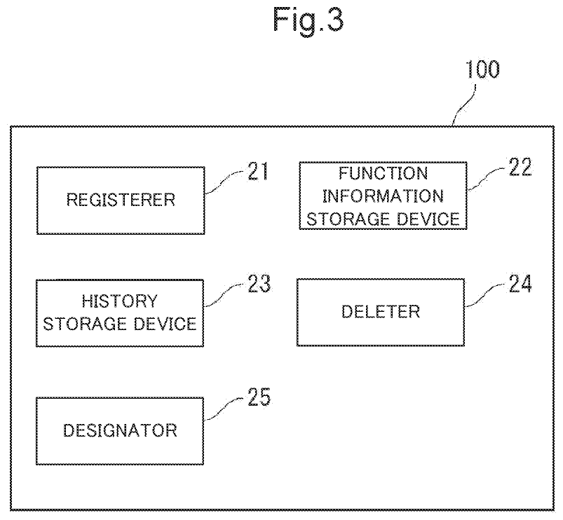

FIG. 3 is a block diagram showing a functional configuration of the image forming apparatus 100. The components cited hereunder are realized, when the arithmetic device 2P of the controller 2 reads out and executes the control program stored in the memory 2M. The controller 2 acts as a registerer 21, a function information storage device 22, a history storage device 23, a deleter 24, and a designator 25. The registerer 21 stores the user information in the memory 2M. The function information storage device 22 stores function information, related to the function to be utilized by the user indicated by the user information registered by the registerer 21, in the memory 2M in association with the user information. The history storage device 23 stores an execution history of a function in the memory 2M, in association with the user information.

The deleter 24 deletes, when an event, predefined as trigger for reducing the number of pieces of user information registered by the registerer 21, has occurred, one or more pieces of user information and the function information from the memory 2M, according to a predetermined rule. The function information storage device 22 stores, when the user information once deleted by the deleter 24 is reregistered by the registerer 21, the function information corresponding to the execution history associated with the reregistered user information, in the memory 2M in association with the user information.

### [Registerer 21]

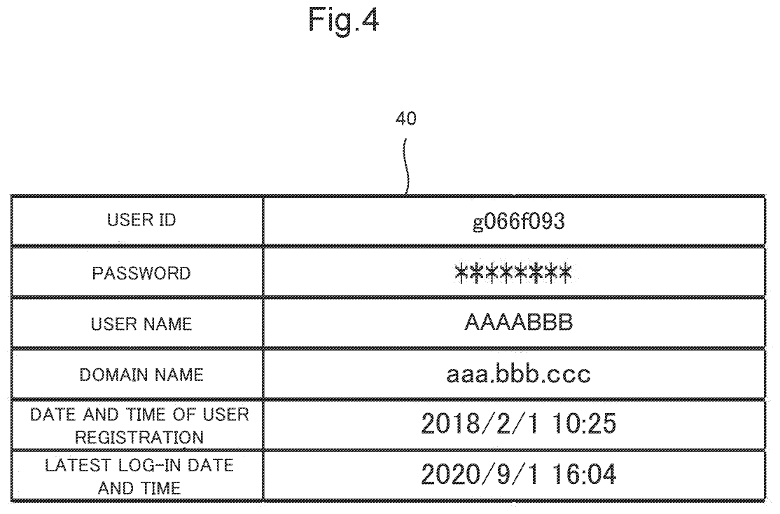

FIG. 4 illustrates an example of user information 40. The registerer 21 stores the user information 40 inputted through a screen for user registration displayed on the display/operation device 19, in the memory 2M. In the example shown in FIG. 4, the information 40 includes a user identifier (ID), a password, the user name, a domain name, date and time of user registration, and a latest log-in date and time. Whereas the information processing system 400 includes the plurality of image forming apparatuses 100 as already described, the same user information 40 can be registered in the plurality of image forming apparatuses 100.

The user ID is the information for identifying the user. The password is the information only accessible by the user, or the user and the manager. The controller 2 permits the user to log in in the image forming apparatus 100, only when the combination of the user ID and the password, inputted by the user through the display/operation device 19, is stored in the memory 2M. Here, the image forming apparatus 100 may be configured to reject the use by a user who has not logged in, or to allow the user who has not logged in to utilize only predetermined minimal functions. In either case, the function information (authorization information) to be subsequently described is applied to each of the functions of the image forming apparatus 100, when the user has logged in.

The user name is, for example, the personal name of the user, which makes it easier to identify the user than the user ID. The domain name represents a part of the uniform resource locator (URL) corresponding to the internet protocol (IP) address assigned to the PC 300. The date and time of user registration represents the date and time that the user has been registered. The latest log-in date and time represents the latest date and time that the user logged in. The latest log-in date and time is updated each time the user logs in.

The registration of the user information 40 may be executed by the manager administrating the information processing system 400, or by the user under the supervision of the manager. In the server 200, the user information (e.g., user ID), the registration of which is permitted, is stored. The user information the registration of which is permitted refers, for example, to the user information corresponding to persons concerned with the organization operating the information processing system 400 (e.g., employees, or employees of a subsidiary company). When the user information 40 is inputted through the display/operation device 19, the controller 2 enquires the server 200 whether the user information corresponding to the inputted user information 40 is stored. The controller 2 registers the user information 40, the registration of which has been requested, only when the user information corresponding to the user information 40 is stored in the server 200.

### [Function Information Storage Device 22]

When the user registration is completed, the function information storage device 22 causes the display/operation device 19 to display a screen for inputting the function information, and stores the inputted function information in the memory 2M, for example in association with the user ID. The function information represents, for example, the sets of the authorization information indicating whether the function may be utilized, with respect to each of the functions. The authorization information indicates one of “Permitted” and “Prohibited”. The manager inputs initial settings prespecified depending on the assigned area or class of position, as the authorization information. When the user wishes to utilize a function, the use of which is not permitted by the initial setting, the manager may input the permission to utilize that function, upon the request from the user to the manager.

When the user logs in in the image forming apparatus 100, the controller 2 causes the display/operation device 19 to display buttons corresponding to the respective functions, so that the user selects the function by operating the button. The controller 2 retrieves the authorization information corresponding to the user ID of the user who has logged in, from the memory 2M, and decides whether the user may utilize each of the functions, according to the authorization information. When the user selects the function set to “Permitted” by the authorization information, the controller 2 executes the operation corresponding to the selected function. When the user selects the function set to “Prohibited” by the authorization information, the controller 2 does not execute the operation corresponding to the selected function.

Here, the controller 2 may display the functions set to “Permitted” by the authorization information and the functions set to “Prohibited” by the authorization information, in different display mode of the button (e.g., color density).

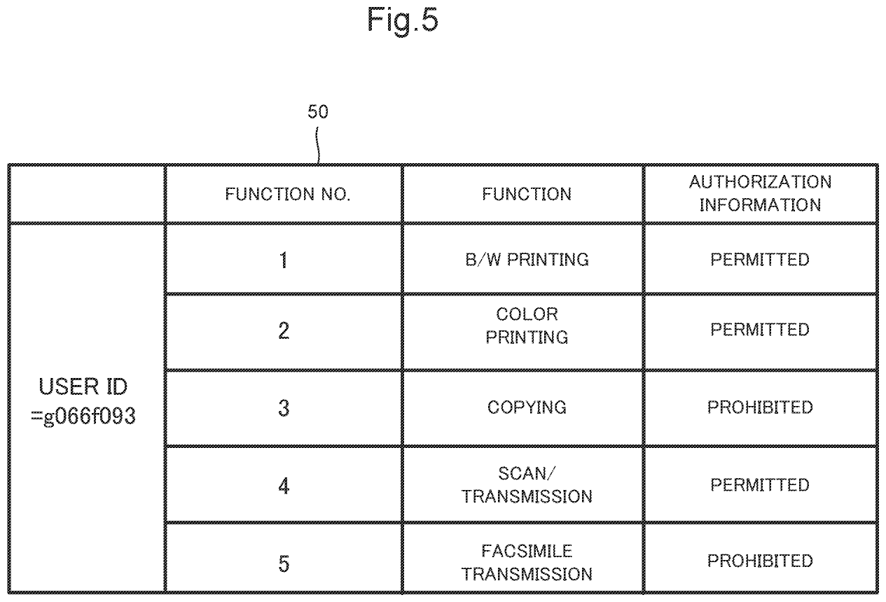

FIG. 5 illustrates an example of the authorization information contained in the function information 50. In the example shown in FIG. 5, the function information storage device 22 is storing the initial settings of the authorization information, with respect to a monochrome printing function, a color printing function, a copying function, a scan/transmission function, and a facsimile transmission function, in the memory 2M. The function information storage device 22 is storing “Permitted” in the memory 2M, as the initial settings of the authorization information with respect to the monochrome printing function, the color printing function, and the scan/transmission function. The function information storage device 22 is storing “Prohibited” in the memory 2M, as the initial settings of the authorization information with respect to the copying function and the facsimile transmission function.

### [History Storage Device 23]

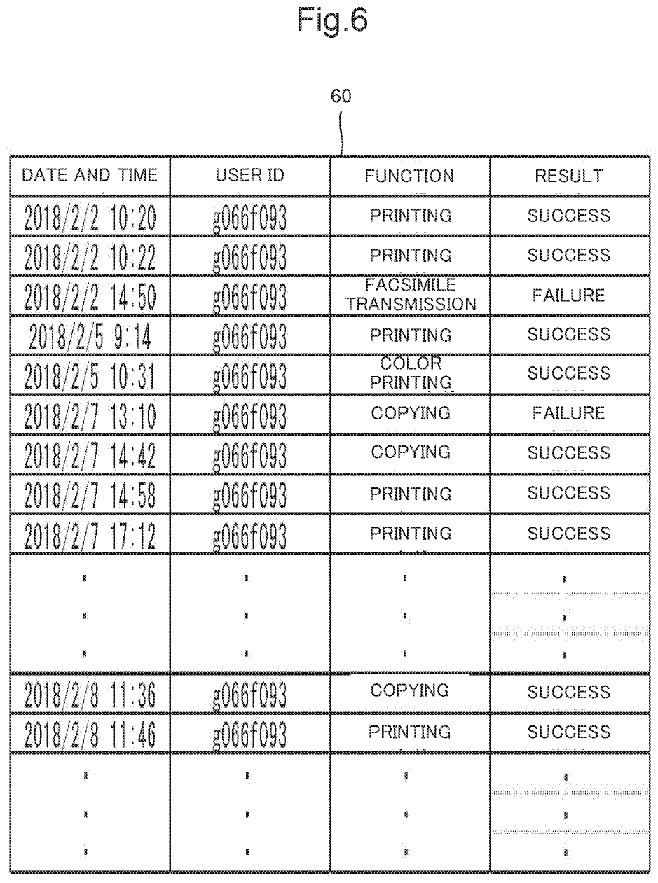

FIG. 6 illustrates an example of an execution history 60 of the jobs. The history storage device 23 stores the execution history of all the jobs, the execution of which was instructed to the image forming apparatus 100, via the PC 300 or the display/operation device 19, in the memory 2M. Practically, the history storage device 23 stores the execution history in the memory 2M, with respect to all the users. The example shown in FIG. 6 represents the execution history of only one user (user ID=g066f093).

The job execution history 60 includes the data and time that the job was received, the user ID, the function designated by the job, and the result of the job. When the job (monochrome printing, color printing) was received via the PC 300, the history storage device 23 stores the user ID associated with the PC 300, in the execution history 60. When the job was received via the display/operation device 19, the history storage device 23 stores the user ID of the user who logged in in the image forming apparatus 100, in the execution history 60.

Upon receipt of a job, the controller 2 looks up the function information corresponding to the user ID, and decides whether the function may be utilized. When the function designated by the job is set to “Permitted” by the authorization information, the controller 2 executes the operation using the selected function, and the history storage device 23 stores “Success” in the execution history 60, as the result of the job. On the other hand, in the case where the job has not been completed for some reason, the history storage device 23 stores “Failure” in the execution history 60. When the function designated by the job is set to “Prohibited” by the authorization information, the controller 2 does not execute the operation using the selected function, and the history storage device 23 stores “Failure” in the execution history 60, as the result of the job.

The authorization information is inputted by the manager, in accordance with the arrangement by the organization operating the information processing system 400. However, the authorization information may be revised, upon the request of the user or the department to which the user belongs. Referring to FIG. 5 and FIG. 6, since the copying function is set to “Prohibited” by the authorization information, the history storage device 23 stores “Failure” in the execution history 60, as the result of a first job using the copying function (Feb. 7, 2018, 13:10). Thereafter, when the manager revises the authorization information for the copying function to “Permitted” upon the request from the user side, the history storage device 23 stores “Success” in the execution history 60, as the result of a second job using the copying function (Feb. 7, 2018, 14:42).

### [Deleter 24]

The deleter 24 deletes, when an event predefined as trigger for reducing the number of pieces of user information registered by the registerer 21 has occurred, one or more pieces of user information and the associated function information from the memory 2M, according to the predetermined rule. In the deleter 24, for example, the case where the number of pieces of registered user information has reached an upper limit is defined in advance, as the predefined event. The upper limit is determined in advance, depending on the storage capacity of the memory 2M, the processing speed of the image forming apparatus 100, or the number of concerned persons in the organization operating the information processing system 400. The predetermined rule refers to, for example, selecting the user information that was registered at the earliest date and time, among the registered user information.

When the user corresponding to the user information, the registration of which has been deleted by the deleter 24, wishes to use the image forming apparatus 100, the registerer 21 has to reregister the user information that was once deleted. When the user information is reregistered by the registerer 21, the function information storage device 22 operates as follows.

When the user information the registration of which has been deleted by the deleter 24 is reregistered by the registerer 21, the function information storage device 22 stores the function information corresponding to the execution history associated with the reregistered user information, in the memory 2M in association with the user information. To be more specific, when the execution history indicating that the operation using a first function, the initial setting of which is “Prohibited” according to the authorization information, has been successfully completed, is stored in the memory 2M, with respect to the user information reregistered by the registerer 21, the function information storage device 22 revises the authorization information for the first function from “Prohibited” to “Permitted”, and stores the revised authorization information in the memory 2M, in association with the user information. In addition, the function information storage device 22 extracts the execution history over a predetermined period, associated with the user information reregistered by the registerer 21, from the memory 2M, and extracts the execution history indicating that the operation using the first function the initial setting of which is “Prohibited” has been successfully completed, from the extracted execution history.

### [Designator 25]

The designator 25 serves to accept the designation of the predetermined period for extracting the execution history, indicating that the operation using the function the initial setting of which is “Prohibited” has been successfully completed. For example, when the manager has logged in, the designator 25 causes the display/operation device 19 to display a screen for account management, and accepts the designation of the predetermined period, inputted by the manager through the displayed screen.

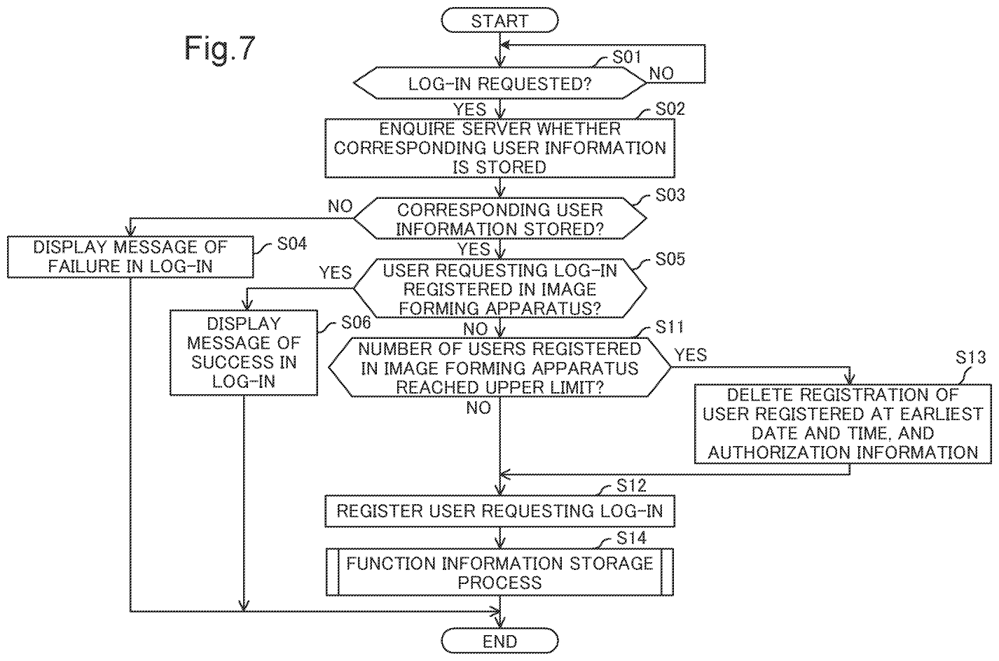

Hereunder, an account management executed by the controller 2 will be described. FIG. 7 is a flowchart showing the process of the account management. When power to the image forming apparatus 100 is turned on, the controller 2 executes the account management, according to the flowchart shown in FIG. 7.

In the process of the account management, first, the controller 2 decides whether a request for logging in has been received via the display/operation device 19 (step S01). Upon deciding that the request for logging in has not been received (NO at step S01), the controller 2 repeats the operation of step S01. Upon deciding, in contrast, that the request for logging in has been received (YES at step S01), the controller 2 enquires the server 200 whether the user information (e.g., user ID and password), inputted through the display/operation device 19 by the user requesting for logging in, is stored in the server 200 (step S02).

Upon receipt of the response from the server 200 to the effect that such user information is not stored therein (NO at step S03), the controller 2 causes the display/operation device 19 to display a message indicating the failure in logging in (step S04). In contrast, upon receipt of the response from the server 200 to the effect that such user information is stored therein (YES at step S03), the controller 2 decides whether the inputted user information (e.g., user ID and password) is registered in the image forming apparatus 100 (step S05).

To be more specific, the controller 2 looks up the user information stored in the memory 2M, and when the user information corresponding to the inputted user information (e.g., user ID and password) is stored in the memory 2M (YES at step S05), the controller 2 causes the display/operation device 19 to display a message indicating the success in logging in (step S06). In contrast, when the user information corresponding to the inputted user information (e.g., user ID and password) is not stored in the memory 2M (NO at step S05), the controller 2 decides whether the number of pieces of user information registered in the image forming apparatus 100 has reached the upper limit (step S11).

When the controller 2 decides that the number of pieces of registered user information has not reached the upper limit (NO at step S11), the registerer 21 registers the inputted user information in the memory 2M (step S12), and proceeds to the function information storage process of step S14. In contrast, when the controller 2 decides that the number of pieces of registered user information has reached the upper limit (YES at step S11), the deleter 24 deletes the user information that was registered at the earliest date and time and the associated authorization information, from the memory 2M (step S13). After step S13, the registerer 21 registers the inputted user information in the memory 2M (step S12), and proceeds to the function information storage process of step S14.

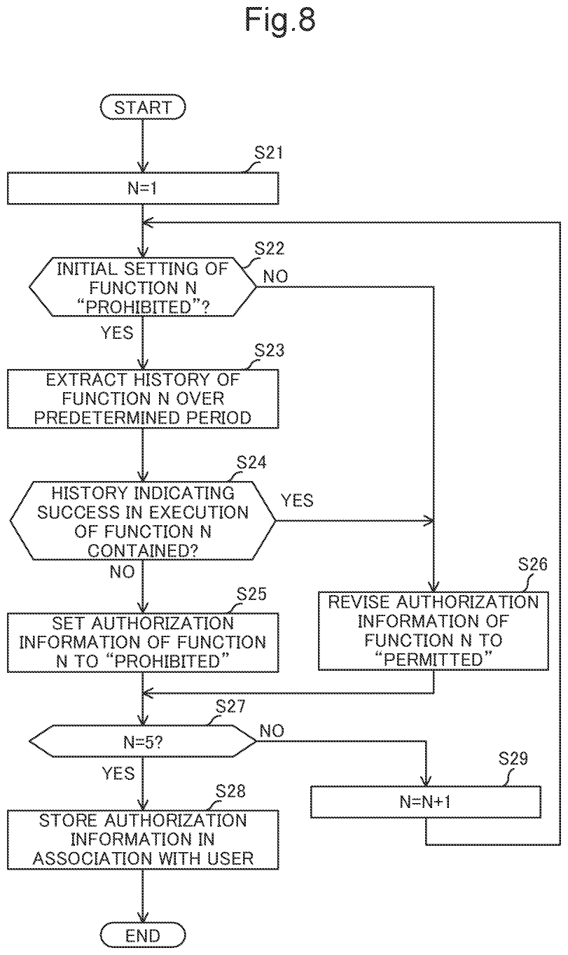

At step S14, the controller 2 executes the function information storage process. FIG. 8 is a flowchart showing the function information storage process. In the function information storage process, first the controller 2 sets a variable N to 1 (step S21). The variable N refers, for example, to a counter indicating the function number shown in FIG. 5. After step S21, the controller 2 looks up the authorization information, for example contained in the function information 50 shown in FIG. 5, and decides whether the initial setting by the authorization information, corresponding to the function number indicated by the variable N, is “Prohibited” (step S22).

When the initial setting is not “Prohibited” (NO at step S22), the controller 2 proceeds to step S26 to be subsequently described. When the initial setting is “Prohibited” (YES at step S22), the controller 2 extracts the execution history of the variable N over the predetermined period (step S23). The predetermined period is, for example, set to 120 days by the controller 2. After step S23, the controller 2 decides whether the execution history, indicating that the function corresponding to the function number indicated by the variable N has been successfully completed, is contained in the extracted execution history (step S24).

When the execution history indicating the success in executing the function is contained in the extracted execution history (YES at step S24), the controller 2 sets the authorization information corresponding to the function number indicated by the variable N, to “Permitted” (step S26). In contrast, when the execution history indicating the success in executing the function is not contained in the extracted execution history (NO at step S24), the controller 2 sets the authorization information corresponding to the function number indicated by the variable N, to “Prohibited” (step S25).

After step S25 or step S26, the controller 2 decides whether the variable N has reached 5 (step S27). “5” is the number of pieces of authorization information, contained in the function information 50. Upon deciding that the variable N has not reached 5 (NO at step S27), the controller 2 adds 1 to the variable N (step S29), and repeats the operation of step S22 and the subsequent steps. In contrast, upon deciding that the variable N has reached 5 (YES at step S27), the controller 2 stores the authorization information contained in the function information 50, in the memory 2M in association with the user information (step S28).

Now, there is an issue that has to be settled, regarding the deletion of the user information. When the registration of the user information is deleted, in general, the authorization information associated with the user is also deleted. However, there may be cases where the user, whose registration has once been deleted, requests reregistration of the user information. In such cases, the authorization information, specified depending on the assigned area or class of position, has to be associated with the corresponding user information, in addition to reregistering the user information. When the user wishes to utilize the first function, the initial setting of which is “Prohibited” according to the authorization information, the user has to again request for the permission to the manager, which imposes a trouble on both of the user and the manager. In particular, when the upper limit of the number of pieces of user information that can be registered is excessively small, in proportion to the scale of the organization, the registration has to be frequently deleted, resulting in increase in burden of the revising operation.

To cope with the mentioned drawbacks, a technique has been developed including automatically granting the authorization to register a new user, to the user already registered. In this case, although the work of the manager can be reduced, the user already registered is not exempted from the work, and therefore the amount of the work by the organization as a whole is not reduced.

According to this embodiment, in contrast, the image forming apparatus 100 includes the registerer 21 that registers the user information, the function information storage device 22 that stores the function information, related to the function to be utilized by the user indicated by the user information registered by the registerer 21, in the memory 2M in association with the user information, the history storage device 23 that stores the function execution history in the memory 2M, in association with the user information, and the deleter 24 that deletes, when the event predefined as trigger for reducing the number of pieces of user information registered by the registerer 21 has occurred, one or more pieces of user information and the function information from the memory 2M, according to the predetermined rule. The function information storage device 22 stores, when the user information deleted by the deleter 24 is reregistered by the registerer 21, the function information corresponding to the execution history associated with the reregistered user, in the memory 2M in association with the user information. The mentioned arrangement eliminates the need to store the function information when reregistering the user information, thereby alleviating the burden accompanying the reregistration of the user information, the registration of which was once deleted.

According to the foregoing embodiment, the function information storage device 22 stores the authorization information indicating whether the function may be utilized, with respect to each of the functions, in the memory 2M as the function information. As result, the work of inputting the authorization information can be saved, when the user information is to be reregistered.

According to the foregoing embodiment, when the execution history indicating that the operation using the first function, the initial setting of which is “Prohibited” according to the authorization information, has been successfully completed, is stored in the memory 2M, with respect to the user information reregistered by the registerer 21, the function information storage device 22 revises the authorization information for the first function from “Prohibited” to “Permitted”, and stores the revised authorization information in the memory 2M, in association with the user information. The mentioned arrangement prevents the function that was set to “Permitted” before the deletion of the registration, from being set to “Prohibited” after the reregistration.

According to the foregoing embodiment, the function information storage device 22 extracts the execution history over the predetermined period, associated with the user information reregistered by the registerer 21, from the memory 2M, and extracts the execution history indicating that the operation using the first function the initial setting of which is “Prohibited” has been successfully completed, from the extracted execution history. When the authorization information is revised during the period between the registration and the deletion of the user information, it is less disadvantageous to the user to utilize the latest authorization information before the deletion, after the reregistration. The execution history over the predetermined period before the deletion is adopted in the foregoing embodiment, and therefore the latest authorization information before the deletion is highly likely to be utilized, after the reregistration.

According to the foregoing embodiment, further, the designator 25 serves to accept the designation of the predetermined period for extracting the execution history, indicating that the operation using the function the initial setting of which is “Prohibited” has been successfully completed. Such an arrangement allows the predetermined period to be adjusted, thereby increasing the likelihood that the latest authorization information before the deletion can be utilized, after the reregistration.

The foregoing embodiment may be modified as follows. For example, in addition to the arrangement according to the embodiment, the function information storage device 22 may revise, when the execution history indicating that the operation using a second function, the initial setting of which is “Permitted” according to the authorization information, has failed, is stored in the memory 2M, with respect to the user information reregistered by the registerer 21, the authorization information for the second function from “Permitted” to “Prohibited”, and store the revised authorization information in the memory 2M, in association with the user information. The mentioned arrangement prevents the function that was set to “Prohibited” before the deletion of the user information, from being set to “Permitted” after the reregistration.

Although the configuration according to the disclosure is applied to the image forming apparatus 100 in the foregoing embodiment, the disclosure is applicable to an information processing apparatus other than the image forming apparatus 100 (e.g., server 200). The information processing system 400 includes the plurality of image forming apparatuses 100 (see FIG. 1). The server 200 may store therein the user information and the function information, in association with each of the image forming apparatuses 100, and execute the account management according to the embodiment, with respect to each of the image forming apparatuses 100.

Although the function information according to the foregoing embodiment contains the authorization information indicating whether the function may be utilized, with respect to each of the functions, the disclosure is not limited to such an embodiment. In a variation of the embodiment, for example, the function information contains set values, selected in advance out of the set values that can be specified with respect to each of the functions of the image forming apparatus 100.

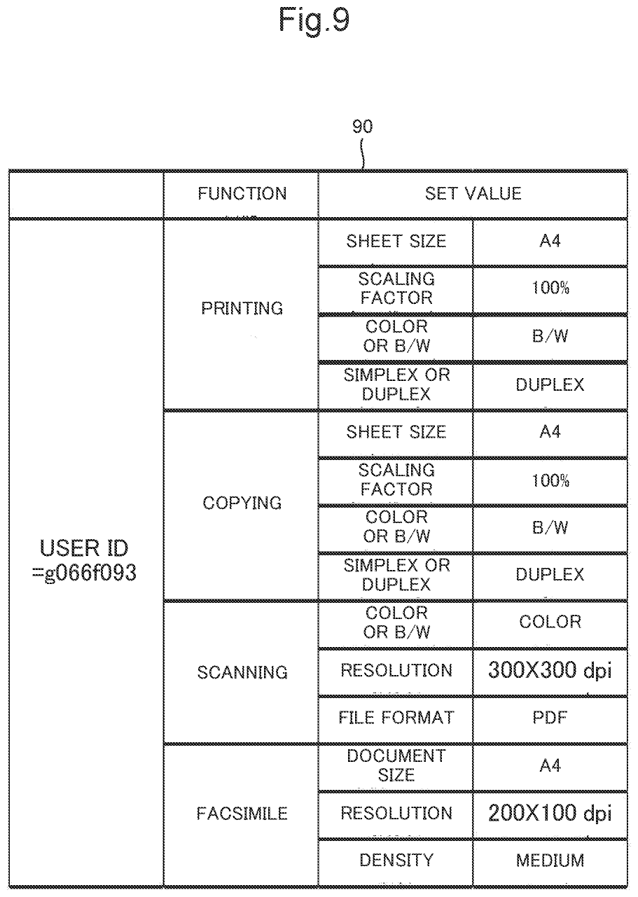

FIG. 9 illustrates examples of the set values contained in the function information 90 according to the variation. In the examples shown in FIG. 9, the function information storage device 22 is storing the respective set values for the printing function, the copying function, the scanning function, and the facsimile function, in the memory 2M. For example, the set values for the printing function stored by the function information storage device 22 in the memory 2M include the set values indicating a sheet size, scaling factor, color printing or monochrome printing, and simplex printing or duplex printing. The set values for the copying function stored by the function information storage device 22 in the memory 2M include the set values indicating the sheet size, the scaling factor, color copying or monochrome copying, and simplex copying or duplex copying. The set values for the scanning function stored by the function information storage device 22 in the memory 2M include the set values indicating color reading or monochrome reading, resolution, and file format. The set values for the facsimile function stored by the function information storage device 22 in the memory 2M include the set values indicating a document size, resolution, and density.

The history storage device 23 also stores, when storing the job execution history, the set values of the function that has been used, in the memory 2M. When the user information is to be reregistered, the function information storage device 22 retrieves the set values of each function from the execution history, and stores those set values in the memory 2M, as the function information. The set values of each function may not always be the same, but there may be a case where a plurality of set values are used. Therefore, a most frequently used set value among the plurality of set values, or the set value according to the execution history of the latest date and time of execution, may be stored in the memory 2M.

When the user logs in in the image forming apparatus 100, the controller 2 causes the display/operation device 19 to display the buttons corresponding to the respective functions, so that the user selects the function by operating the button. The controller 2 retrieves the function information associated with the user ID of the user who has logged in, from the memory 2M, and applies the set values contained in the function information to the respective functions. Such arrangement according to this variation alleviates the trouble of inputting the set values, when the user information is to be reregistered.

While the present disclosure has been described in detail with reference to the embodiments thereof, it would be apparent to those skilled in the art the various changes and modifications may be made therein within the scope defined by the appended claims.

What is claimed is:

1. An information processing apparatus comprising:
a memory; and
an arithmetic device including a processor, and configured to act, when the processor executes a control program, as:
a registerer that stores user information in the memory;
a function information storage device that stores function information, related to a function to be utilized by a user indicated by the user information registered by the registerer, in the memory in association with the user information;
a history storage device that stores an execution history of the function in the memory, in association with the user information; and
a deleter that deletes, when an event, predefined as trigger for reducing a number of pieces of user information registered by the registerer, has occurred, one or more pieces of user information and the function information from the memory, according to a predetermined rule,
wherein the function information storage device stores, when the user information deleted by the deleter is reregistered by the registerer, the function information corresponding to the execution history associated with the reregistered user information, in the memory in association with the user information.

2. The information processing apparatus according to claim 1,
wherein the function information storage device stores authorization information indicating whether the function may be utilized, with respect to each of the functions, in the memory as the function information.

3. The information processing apparatus according to claim 2,
wherein, when the execution history indicating that an operation using a first function, an initial setting of which is “prohibited” according to the authorization information, has been successfully completed, is stored in the memory, with respect to the user information reregistered by the registerer, the function information storage device revises the authorization information for the first function from “prohibited” to “permitted”, and stores the revised authorization information in the memory, in association with the user information.

4. The information processing apparatus according to claim 3,
wherein the function information storage device extracts the execution history over a predetermined period, associated with the user information reregistered by the registerer, from the memory, and extracts the execution history indicating that the operation using the first function the initial setting of which is “prohibited” has been successfully completed, from the extracted execution history.

5. The information processing apparatus according to claim 4,
wherein the arithmetic device further acts as a designator that accepts designation of the predetermined period.

6. The information processing apparatus according to claim 2,
wherein, when the execution history indicating that an operation using a second function, the initial setting of which is “permitted” according to the authorization information, has failed, is stored in the memory, with respect to the user information reregistered by the registerer, the function information storage device revises the authorization information for the second function from “permitted” to “prohibited”, and stores the revised authorization information in the memory, in association with the user information.
